(19) United States
(12) Patent Application Publication
(10) Pub. No.: US 2025/0100110 A1
(43) Pub. Date: Mar. 27, 2025

(54) DEEP-HOLE SOCKET DRIVING SHANK ASSEMBLY

(71) Applicant: Bing-Cheng Liao, Changhua County (TW)

(72) Inventors: Bing-Cheng Liao, Changhua County (TW); Hsuan-Yu Huang, Taichung City (TW)

(21) Appl. No.: 18/822,870

(22) Filed: Sep. 3, 2024

(30) Foreign Application Priority Data
Sep. 22, 2023 (TW) 112136271

(51) Int. Cl. B25B 21/00; B25B 23/00

(52) U.S. Cl. CPC B25B 21/002; B25B 23/0035

(57) ABSTRACT

A driving shank assembly includes a tube, a drive head, a connector, and two quick release nuts. The tube has two mounting portions each provided with an external thread or a screw hole. The drive head is provided with an external thread or a screw hole. The connector is provided with an external thread or a screw hole. Each of the quick release nuts is provided with a first internal thread screwed onto the external thread of the tube or a first through hole locked onto the screw hole of the tube. Each of the quick release nuts is provided with a second internal thread screwed onto the external thread of the drive head and screwed onto the external thread of the connector or a second through hole locked onto the screw hole of the drive head and locked onto the screw hole of the connector.

### BACKGROUND OF THE INVENTION

### Field of the Invention

The present invention relates to a hand operated tool and, more particularly, to a deep-hole socket driving shank assembly.

### Description of the Related Art

A conventional deep-hole socket driving shank assembly comprises a tube having a first end provided with a driving head, and a connecting member having a first end secured to a second end of the tube by welding and a second end provided with a shank. The driving head is provided with a driving recess. The shank is provided with an annular groove for locking an electric tool. In practice, two bolts are mounted on a ceiling. A support plate is mounted between the two bolts. Two nuts are screwed onto the two bolts and rest on the bottom of the support plate to support the support plate. Thus, the support plate is used to support a vent pipe or a fire hose. The driving recess of the driving head is mounted on each of the two nuts. The electric tool is connected with the shank of the connecting member. In operation, the connecting member is driven by the electric tool to rotate the tube which rotates the driving head which rotates each of the two nuts so that each of the two nuts is screwed onto or unscrewed from each of the two bolts. However, the tube and the connecting member are not coaxial and have a poor circularity therebetween so that the tube is easily deflected during rotation. In addition, the tube, the driving head, and the connecting member are formed integrally so that the tube, the driving head, and the connecting member cannot be dismantled, so that the driving head is not available for nuts of different sizes and specifications. Further, it is necessary replace the whole socket driving shank assembly when the driving head or the connecting member is worn out or broken, thereby causing a waste of material, and thereby increasing the cost of replacement and maintenance.

### BRIEF SUMMARY OF THE INVENTION

The primary objective of the present invention is to provide a driving shank assembly having a simplified construction.

In accordance with one embodiment of the present invention, there is provided a driving shank assembly comprising a tube, a drive head, a connector, and two quick release nuts. The tube is a hollow straight tube. The tube has two mounting portions formed on two ends thereof. Each of the two mounting portions of the tube has a circular shape and has an interior provided with a mounting recess for mounting the drive head and the connector respectively. The mounting recess has a circular shape. Each of the two mounting portions has an exterior provided with an external thread or a screw hole for locking and securing each of the two quick release nuts. Each of the two mounting portions of the tube has a periphery provided with multiple positioning slots extending along an axis of the tube. Each of the positioning slots of the tube is provided with a positioning face. The drive head has a first end provided with a driving recess. The drive head has a second end provided with multiple positioning projections inserted into and positioned in the positioning slots of one of the two mounting portions of the tube. The drive head has an exterior provided with an external thread or a screw hole for locking and securing one of the two quick release nuts. The connector has a first end provided with a connecting head for mounting an actuating tool. The connector has a second end provided with multiple positioning projections inserted into and positioned in the positioning slots of one of the two mounting portions of the tube. The connector has an exterior provided with an external thread or a screw hole for locking and securing one of the two quick release nuts. Each of the two quick release nuts is provided with a first internal thread screwed onto the external thread of the tube or provided with a first through hole locked onto the screw hole of the tube. Each of the two quick release nuts is provided with a second internal thread screwed onto the external thread of the drive head and screwed onto the external thread of the connector or provided with a second through hole locked onto the screw hole of the drive head and locked onto the screw hole of the connector.

In accordance with another embodiment of the present invention, there is provided a driving shank assembly comprising a tube, a drive head, a connector, and two quick release nuts. The tube is a hollow straight tube. The tube has two mounting portions formed on two ends thereof. Each of the two mounting portions of the tube is provided with a non-circular fitting portion for fitting and securing each of the two quick release nuts. The drive head is provided with a driving recess. The drive head is provided with a non-circular fitting portion for fitting and securing one of the two quick release nuts. The connector is provided with a connecting head for mounting an actuating tool. The connector is provided with a non-circular fitting portion for fitting and securing one of the two quick release nuts. Each of the two quick release nuts is provided with a non-circular fitting hole fitted and secured on the fitting portion of the tube, the fitting portion of the drive head, and the fitting portion of the connector.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a driving shank assembly in accordance with the first preferred embodiment of the present invention.

FIG. 2 is an exploded perspective view of the driving shank assembly as shown in FIG. 1.

FIG. 3 is a cross-sectional view of the driving shank assembly as shown in FIG. 1.

FIG. 4 is a cross-sectional view of the driving shank assembly taken along line B-B as shown in FIG. 3.

FIGS. 5-7 are cross-sectional views showing assembly of the tube, the connector, and one of the two quick release nuts of the driving shank assembly.

FIG. 8 is a schematic planar operational view showing operation of the driving shank assembly as shown in FIG. 1 in use.

FIG. 9 is a perspective view of a driving shank assembly in accordance with the second preferred embodiment of the present invention.

FIG. 10 is an exploded perspective view of the driving shank assembly as shown in FIG. 9.

FIG. 11 is a cross-sectional view of the driving shank assembly as shown in FIG. 9.

FIG. 12 is a cross-sectional view of the driving shank assembly taken along line F-F as shown in FIG. 11.

FIGS. 13-15 are cross-sectional views showing assembly of the tube, the connector, and one of the two quick release nuts of the driving shank assembly.

FIG. 16 is a cross-sectional view showing assembly of the tube, the connector, and one of the two quick release nuts of the driving shank assembly in accordance with the third preferred embodiment of the present invention.

FIG. 17 is an exploded perspective view of a driving shank assembly in accordance with the fourth preferred embodiment of the present invention.

FIG. 18 is a cross-sectional assembly view of the driving shank assembly as shown in FIG. 17.

FIG. 19 is a cross-sectional view of the driving shank assembly taken along line J-J as shown in FIG. 18.

FIG. 20 is an exploded perspective view of a driving shank assembly in accordance with the fifth preferred embodiment of the present invention.

FIG. 21 is a cross-sectional assembly view of the driving shank assembly as shown in FIG. 20.

FIG. 22 is a cross-sectional view of the driving shank assembly taken along line P-P as shown in FIG. 21.

FIG. 23 is an exploded perspective view of a driving shank assembly in accordance with the sixth preferred embodiment of the present invention.

FIG. 24 is a cross-sectional assembly view of the driving shank assembly as shown in FIG. 23.

FIG. 25 is a cross-sectional view of the driving shank assembly taken along line Y-Y as shown in FIG. 24.

### DETAILED DESCRIPTION OF THE INVENTION

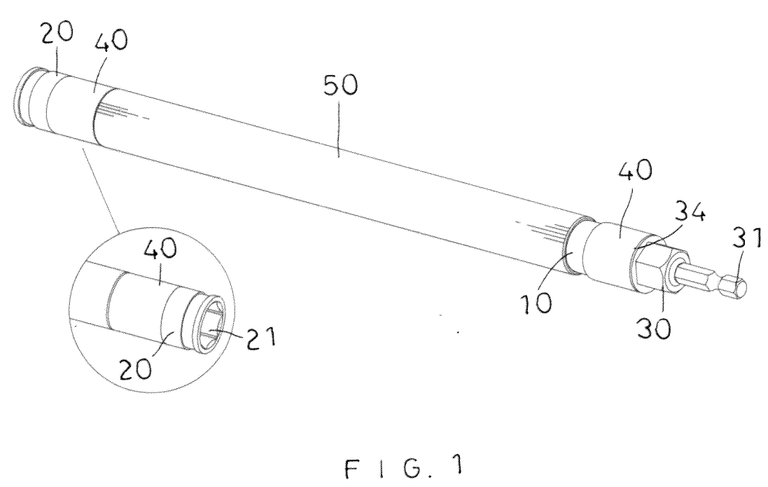

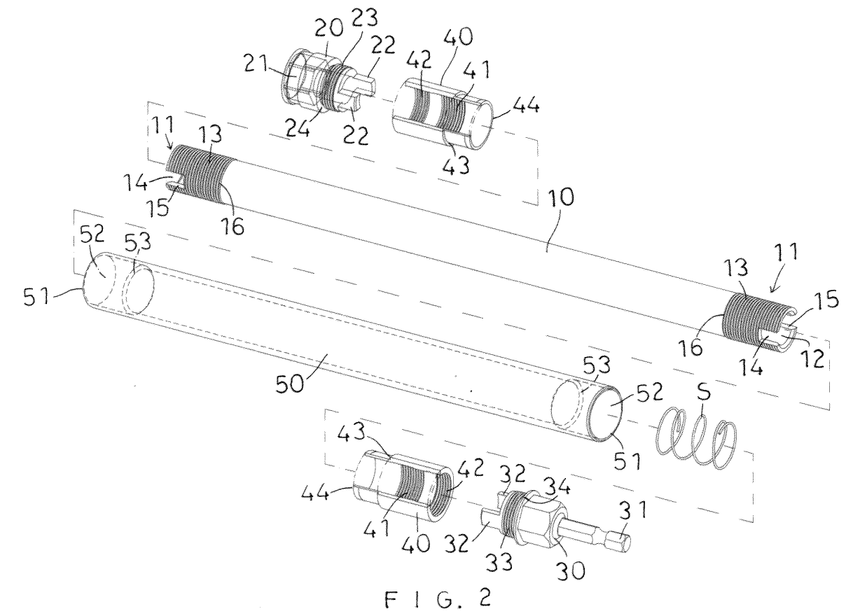

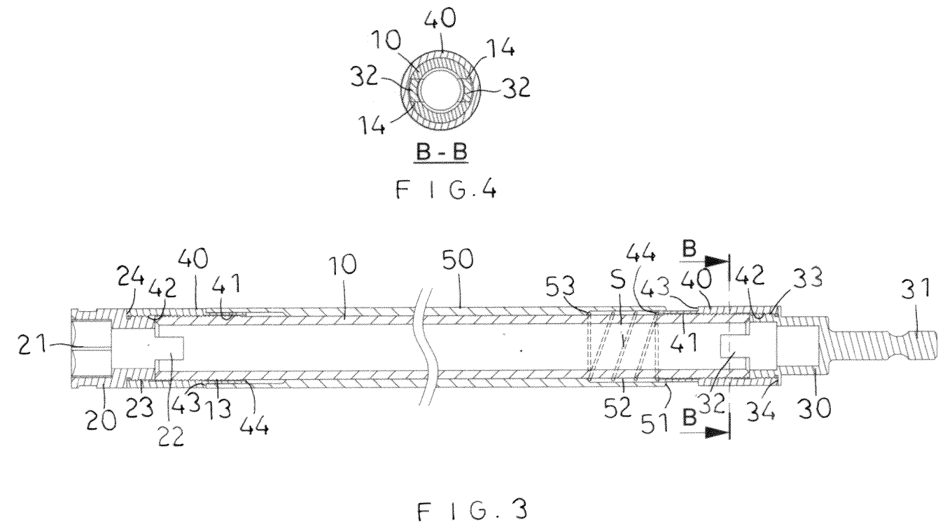

Referring to the drawings and initially to FIGS. 1-4, a driving shank assembly in accordance with the preferred embodiment of the present invention comprises a tube 10, a drive head (or first drive head) 20, a connector 30, and two quick release nuts 40.

The tube 10 is a hollow straight tube. The tube 10 has two mounting portions 11 formed on two ends thereof. Each of the two mounting portions 11 of the tube 10 has a circular shape and has an interior provided with a mounting recess 12 for mounting the drive head 20 and the connector 30 respectively. The mounting recess 12 has a circular shape. Each of the two mounting portions 11 has an exterior provided with an external thread 13 for locking and securing each of the two quick release nuts 40. Each of the two mounting portions 11 of the tube 10 has a periphery provided with multiple positioning slots 14 extending along an axis of the tube 10. Each of the positioning slots 14 of the tube 10 is provided with a positioning face 15. Preferably, the tube 10 is provided with two outer stepped edges 16. Each of the two outer stepped edges 16 is located at a connection of the tube 10 and one of the two mounting portions 11. Each of the two quick release nuts 40 is moved to touch one of the two outer stepped edges 16 of the tube 10 to prevent an excess movement of each of the two quick release nuts 40 on the tube 10.

The drive head 20 has a first end provided with a driving recess 21. The drive head 20 has a second end provided with multiple positioning projections 22 inserted into and positioned in the positioning slots 14 of one of the two mounting portions 11 of the tube 10 so that the tube 10 and the drive head 20 are combined integrally. The drive head 20 has an exterior provided with an external thread 23 for locking and securing one of the two quick release nuts 40. The driving recess 21 of the drive head 20 has a hexagonal shape or a square shape so that the driving recess 21 of the drive head 20 is available for nuts of different sizes and specifications. The drive head 20 has a periphery provided with a stepped positioning edge 24 for positioning one of the two quick release nuts 40.

The connector 30 has a first end provided with a connecting head (or shank or rod) 31 for mounting an actuating tool, such as an electric tool 1 as shown in FIG. 8. The connector 30 has a second end provided with multiple positioning projections 32 inserted into and positioned in the positioning slots 14 of one of the two mounting portions 11 of the tube 10 so that the tube 10 and the connector 30 are combined integrally. The connector 30 has an exterior provided with an external thread 33 for locking and securing one of the two quick release nuts 40. The connector 30 has a periphery provided with a stepped positioning edge 34 for positioning one of the two quick release nuts 40.

The two quick release nuts 40 are locked onto the two mounting portions 11 of the tube 10 respectively. Each of the two quick release nuts 40 is provided with a first internal thread 41 screwed onto the external thread 13 of the tube 10. The first internal thread 41 of each of the two quick release nuts 40 is moved on the external thread 13 of the tube 10 until one end of the first internal thread 41 of each of the two quick release nuts 40 touches one of the two outer stepped edges 16 of the tube 10 to prevent an excess movement of each of the two quick release nuts 40 on the tube 10. Each of the two quick release nuts 40 is provided with a second internal thread 42 screwed onto the external thread 23 of the drive head 20 and screwed onto the external thread 33 of the connector 30. Thus, when the tube 10 is juxtaposed to and connected with the drive head 20 and the connector 30, the two quick release nuts 40 prevent the tube 10, the drive head 20, and the connector 30 from being deformed die to an excess torque.

The driving shank assembly further comprises a holding cylinder (or sleeve or barrel) 50 rotatably mounted on the tube 10. Thus, the holding cylinder 50 is not rotated with the tube 10 to facilitate a user holding the holding cylinder 50 when the tube 10 is rotated. Each of the two quick release nuts 40 has an exterior provided with a stepped positioning edge 43 for positioning the holding cylinder 50. The holding cylinder 50 is provided with two positioning edges 51 each abutting and positioning the stepped positioning edge 43 of one of the two quick release nuts 40.

The driving shank assembly further comprises an elastic member S biased between the tube 10 and the holding cylinder 50. Each of the two quick release nuts 40 has a periphery provided with a stepped outer abutting edge 44 abutting the elastic member S. The holding cylinder 50 is provided with a spring groove 52 and a stepped inner abutting edge 53. The elastic member S is received and hidden in the spring groove 52 to enhance the aesthetic quality. The elastic member S is positioned without sliding to prevent the elastic member S from hurting the user's hand and to protect the user's safety. The elastic member S has a first end pressing the stepped outer abutting edge 44 and a second end pressing the stepped inner abutting edge 53.

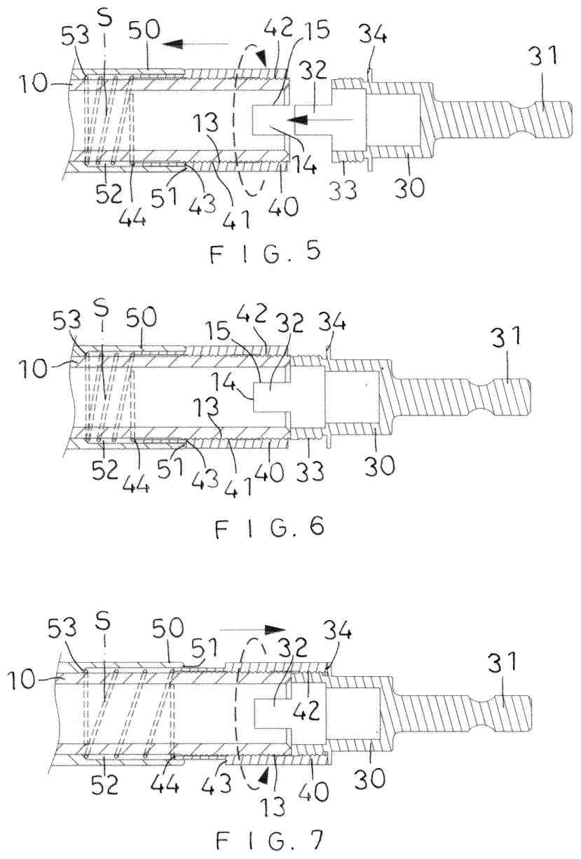

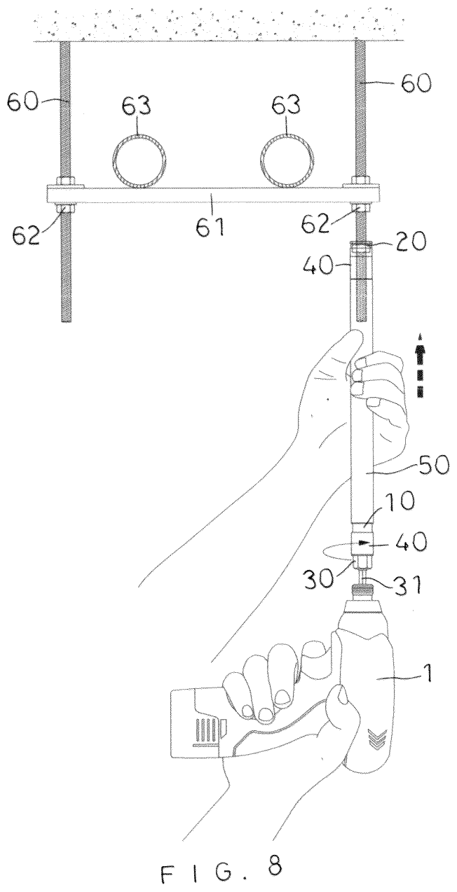

In assembly, referring to FIGS. 5-7 with reference to FIGS. 1-4, the holding cylinder 50 is mounted on the tube 10. Then, each of the two quick release nuts 40 is rotated on the tube 10 so that the first internal thread 41 of each of the two quick release nuts 40 is screwed onto and moved on the external thread 13 of the tube 10 as shown in FIG. 5. Then, the connector 30 (or the drive head 20) is moved toward the tube 10 as shown in FIG. 5, and the positioning projections 32 of the connector 30 (or the positioning projections 22 of the drive head 20) are inserted into the positioning slots 14 of the one of the two mounting portions 11 of the tube 10 until the connector 30 (or the drive head 20) touches and presses the positioning face 15 of the tube 10 as shown in FIG. 6, so that the tube 10 and the connector 30 (or the drive head 20) are combined integrally. Then, each of the two quick release nuts 40 is rotated reversely on the tube 10 so that the second internal thread 42 of each of the two quick release nuts 40 is screwed onto the external thread 33 of the connector 30 (or the external thread 23 of the drive head 20) as shown in FIG. 7. Then, the second internal thread 42 of each of the two quick release nuts 40 is moved successively until each of the two quick release nuts 40 touches and presses the stepped positioning edge 34 of the connector 30 (or the stepped positioning edge 24 of the drive head 20).

In practice, referring to FIG. 8 with reference to FIGS. 1-4, two bolts 60 are mounted on a ceiling. A support plate 61 is mounted between the two bolts 60. After the position of the support plate 61 is adjusted, two nuts 62 are screwed onto the two bolts 60 and rest on the bottom of the support plate 61 to support the support plate 61. Thus, the support plate 61 is used to support at least one pipe 63 which is a vent pipe or a fire hose. Then, the driving recess 21 of the drive head 20 is mounted on each of the two nuts 62. At this time, the tube 10 allows passage of each of the two bolts 60. The holding cylinder 50 is held by the user. The electric tool 1 is connected with the connecting head 31 of the connector 30. In operation, the connector 30 is driven by the electric tool 1 to rotate the tube 10 which rotates the drive head 20 which rotates each of the two nuts 62 so that each of the two nuts 62 is screwed onto or unscrewed from each of the two bolts 60. Thus, the driving shank assembly cooperates with the electric tool 1 to operate each of the two nuts 62 easily and quickly. In such a manner, the drive head 20 and the connector 30 will not be detached from the tube 10 due to vibration of the electric tool 1. In addition, the tube 10, the drive head 20, and the connector 30 are coaxial with each other and have a circularity (or roundness) and precision therebetween so that the driving shank assembly is driven by the electric tool 1 smoothly and steadily and will not be deflected or swayed during rotation.

Accordingly, the driving shank assembly only needs the tube 10, the drive head 20, the connector 30, and the two quick release nuts 40 so that the driving shank assembly is made simply and has a lower cost. In addition, when the tube 10 is juxtaposed to and connected with the drive head 20 and the connector 30, the two quick release nuts 40 prevent the tube 10, the drive head 20, and the connector 30 from being deformed die to an excess torque. Further, the tube 10, the drive head 20, and the connector 30 are coaxial with each other and have a precise circularity therebetween so that the driving shank assembly is driven by the electric tool 1 steadily and will not be deflected during rotation, thereby facilitating the user operating the driving shank assembly. Further, the tube 10, the drive head 20, and the connector 30 are assembled detachably so that the tube 10 cooperates with the drive head 20 and the connector 30 of different sizes and specifications so that the driving shank assembly is available for operating nuts of different types. Further, when the drive head 20 or the connector 30 is worn out or broken, the user only needs to replace the drive head 20 or the connector 30 without having to replace the whole driving shank assembly, thereby saving the cost. Further, each of the two quick release nuts 40 is screwed onto the tube 10 to lock the drive head 20 and the connector 30, or unscrewed from the tube 10 to unlock the drive head 20 and the connector 30, so that the drive head 20 and the connector 30 are mounted on and detached from the tube 10 easily and quickly. Further, the drive head 20 and the connector 30 are positioned on the tube 10 solidly and steadily by the two quick release nuts 40.

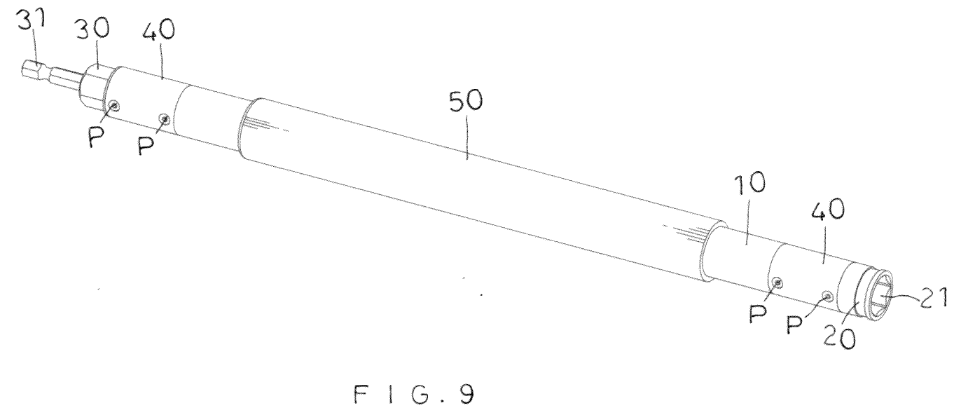

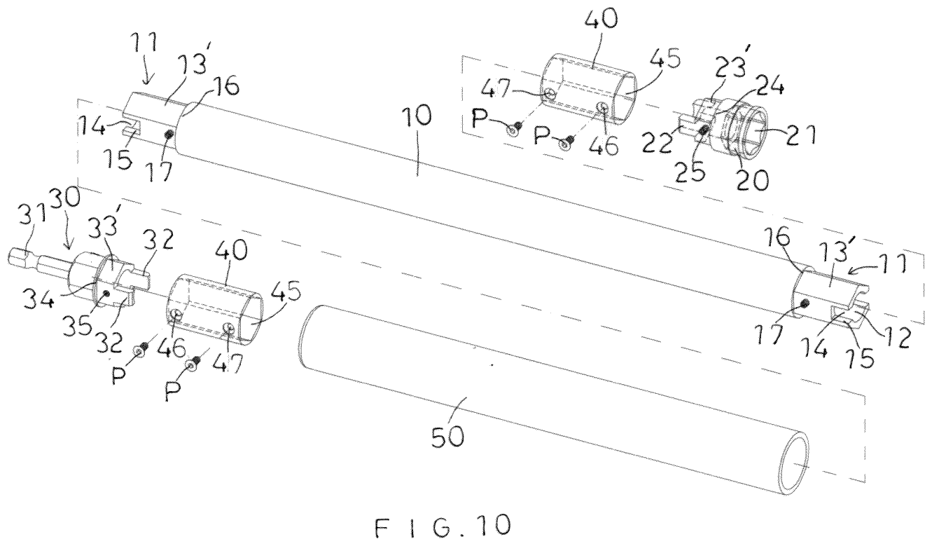

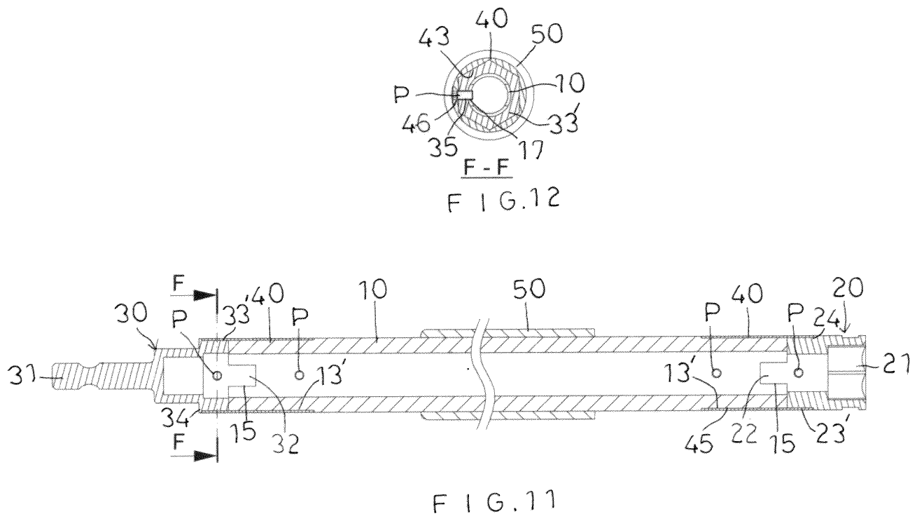

Referring to FIGS. 9-12, each of the two mounting portions 11 has an exterior provided with a screw hole 17 for locking and securing each of the two quick release nuts 40. The drive head 20 has an exterior provided with a screw hole 25 for locking and securing one of the two quick release nuts 40. The connector 30 has an exterior provided with a screw hole 35 for locking and securing one of the two quick release nuts 40. Each of the two quick release nuts 40 is provided with a first through hole 47 locked onto the screw hole 17 of the tube 10. Each of the two quick release nuts 40 is provided with a second through hole 46 locked onto the screw hole 25 of the drive head 20 and locked onto the screw hole 35 of the connector 30.

Each of the two mounting portions 11 of the tube 10 is provided with a non-circular (polygonal or hexagonal) fitting portion 13′ for fitting and securing each of the two quick release nuts 40. The drive head 20 is provided with a non-circular (polygonal or hexagonal) fitting portion 23′ for fitting and securing one of the two quick release nuts 40. The connector 30 is provided with a non-circular (polygonal or hexagonal) fitting portion 33′ for fitting and securing one of the two quick release nuts 40. Each of the two quick release nuts 40 is provided with a non-circular (polygonal or hexagonal) fitting hole 45 fitted and secured on the fitting portion 13′ of the tube 10, the fitting portion 23′ of the drive head 20, and the fitting portion 33′ of the connector 30.

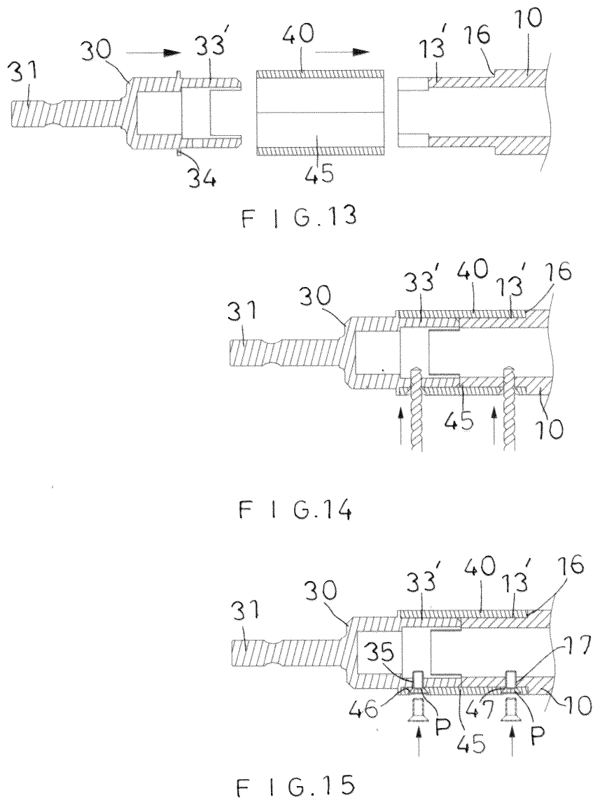

In assembly, referring to FIGS. 13-15 with reference to FIGS. 9-12, the fitting hole 45 of each of the two quick release nuts 40 is mounted on the fitting portion 13′ of the tube 10. Then, the fitting portion 33′ of the connector 30 (or the fitting portion 23′ of the drive head 20) is fitted into the fitting hole 45 of one of the two quick release nuts 40. Then, holes are drilled in the fitting hole 45 of each of the two quick release nuts 40 and the fitting portion 13′ of the tube 10. Then, holes are drilled in the fitting hole 45 of each of the two quick release nuts 40, the fitting portion 23′ of the drive head 20, and the fitting portion 33′ of the connector 30. Thus, the first through hole 47 and the second through hole 46 are formed in each of the two quick release nuts 40. Then, the holes of the fitting portion 13′ of the tube 10, the fitting portion 23′ of the drive head 20, and the fitting portion 33′ of the connector 30 are further drilled to form the screw hole 17 of the tube 10, the screw hole 25 of the drive head 20, and the screw hole 35 of the connector 30. Finally, screws P extend through the first through hole 47 of each of the two quick release nuts 40 and are screwed into the screw hole 17 of the tube 10, extend through the second through hole 46 of one of the two quick release nuts 40 and are screwed into the screw hole 25 of the drive head 20, and extend through the second through hole 46 of the other one of the two quick release nuts 40 and are screwed into the screw hole 35 of the connector 30.

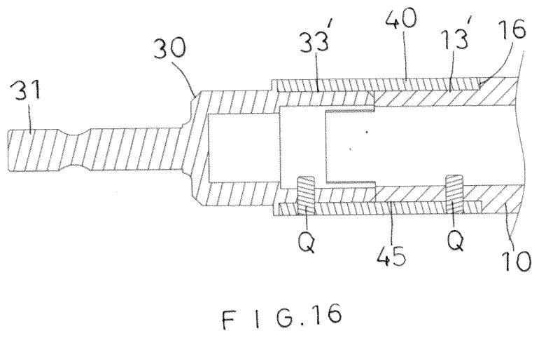

Alternatively, referring to FIG. 16 with reference to FIGS. 9-12, pins P extend through the first through hole 47 and the second through hole 46 of each of the two quick release nuts 40, the holes of the tube 10, the hole of the drive head 20, and the hole of the connector 30.

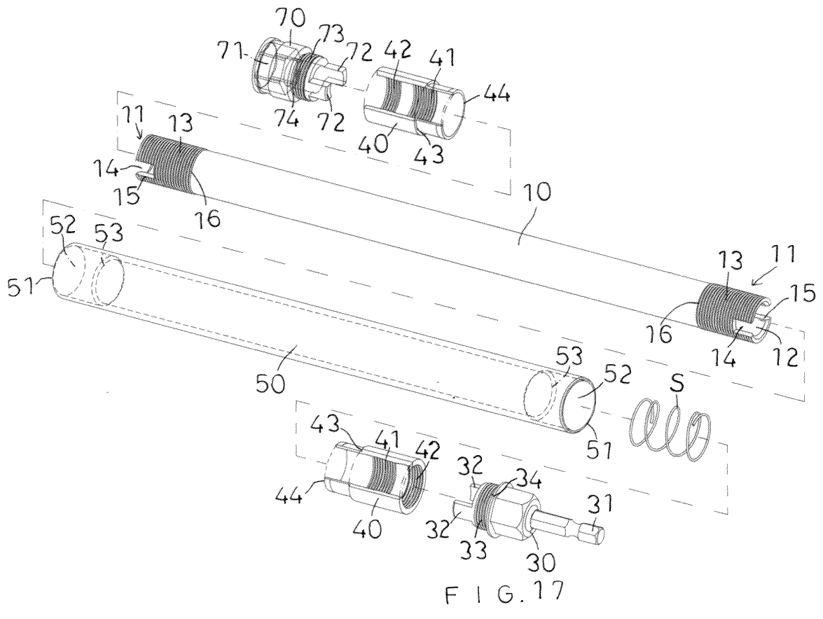

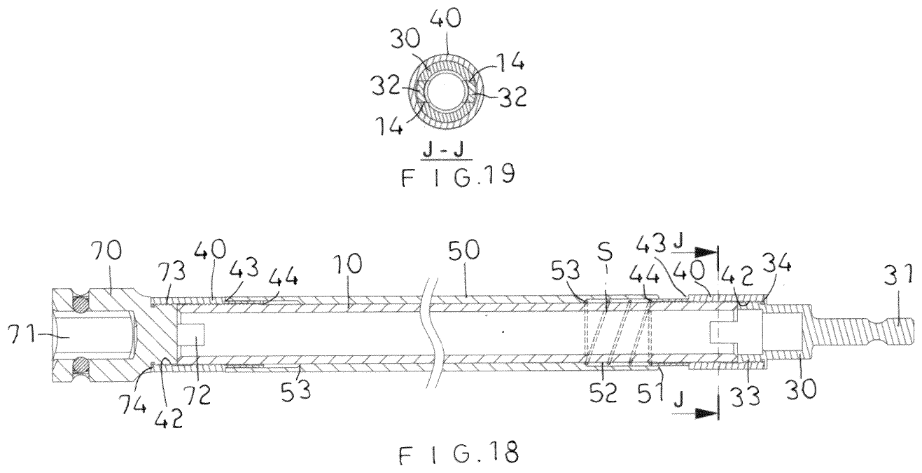

Referring to FIGS. 17-19, the drive head (or second drive head) 70 has a first end provided with a driving recess 71 having a square shape. The drive head 70 has a second end provided with multiple positioning projections 72 inserted into and positioned in the positioning slots 14 of one of the two mounting portions 11 of the tube 10 so that the tube 10 and the drive head 70 are combined integrally. The drive head 70 has an exterior provided with an external thread 73 for locking and securing one of the two quick release nuts 40. The drive head 70 has a periphery provided with a stepped positioning edge 74 for positioning one of the two quick release nuts 40. Each of the two quick release nuts 40 is provided with a second internal thread 42 screwed onto the external thread 73 of the drive head 70 and screwed onto the external thread 33 of the connector 30.

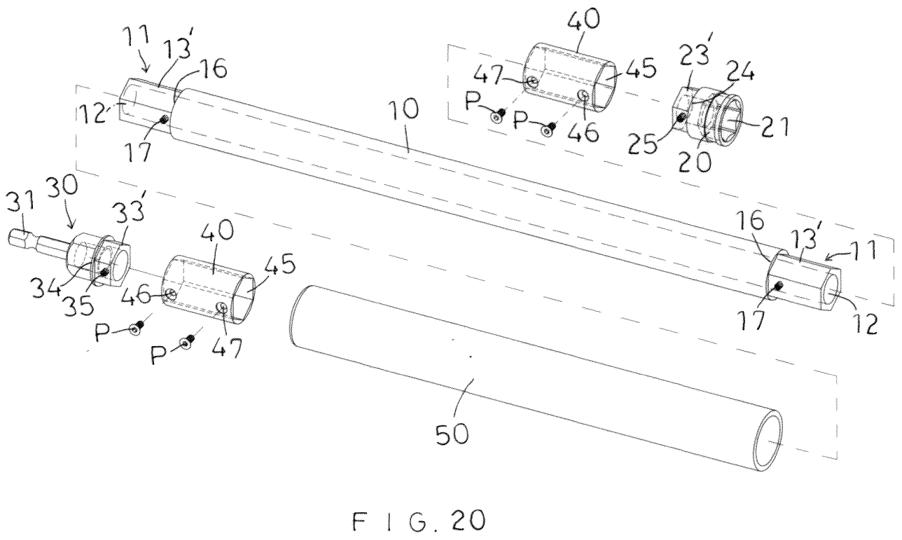

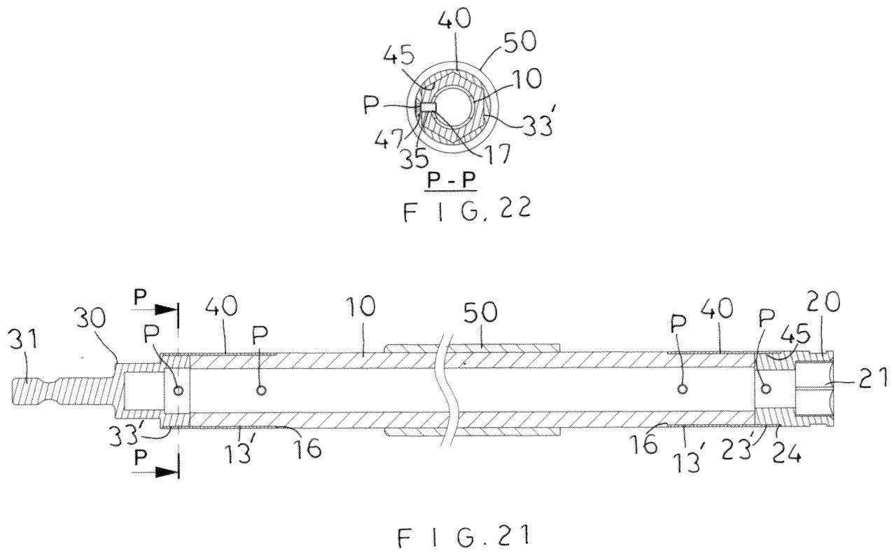

Referring to FIGS. 20-22, the positioning slots 14, the positioning face 15, the positioning projections 22, and the positioning projections 32 are undefined. The screw hole 17 is formed in the fitting portion 13′. The screw hole 25 is formed in the fitting portion 23′. The screw hole 35 is formed in the fitting portion 33′. The first through hole 47 and the second through hole 46 are connected to the fitting hole 45.

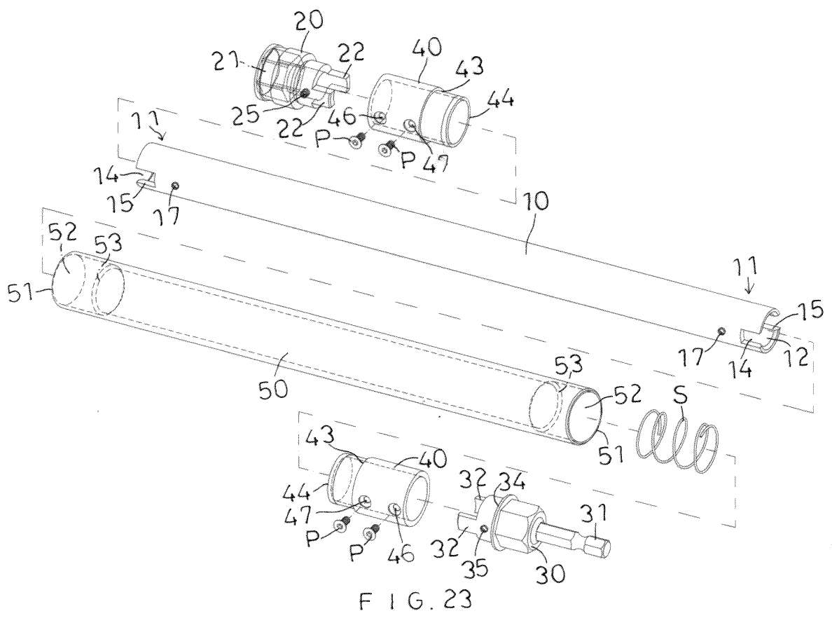

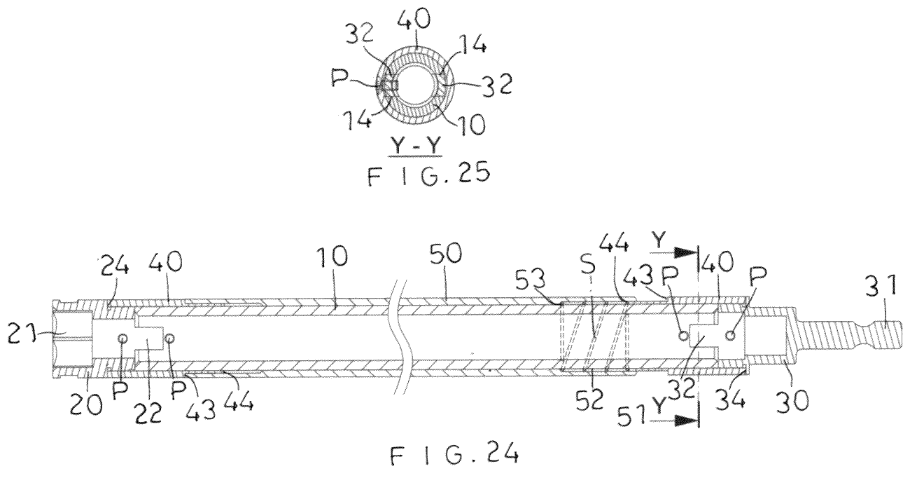

Referring to FIGS. 23-25, the fitting portion 13′, the two outer stepped edges 16, the fitting portion 23′, and the fitting portion 33′ are undefined.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A driving shank assembly comprising:
a tube, a drive head, a connector, and two quick release nuts;
wherein:
the tube is a hollow straight tube;
the tube has two mounting portions formed on two ends thereof;
each of the two mounting portions of the tube has a circular shape and has an interior provided with a mounting recess for mounting the drive head and the connector respectively;
the mounting recess has a circular shape;
each of the two mounting portions has an exterior provided with an external thread or a screw hole for locking and securing each of the two quick release nuts;
each of the two mounting portions of the tube has a periphery provided with multiple positioning slots extending along an axis of the tube;
each of the positioning slots of the tube is provided with a positioning face;
the drive head has a first end provided with a driving recess;
the drive head has a second end provided with multiple positioning projections inserted into and positioned in the positioning slots of one of the two mounting portions of the tube;
the drive head has an exterior provided with an external thread or a screw hole for locking and securing one of the two quick release nuts;
the connector has a first end provided with a connecting head for mounting an actuating tool;
the connector has a second end provided with multiple positioning projections inserted into and positioned in the positioning slots of one of the two mounting portions of the tube;
the connector has an exterior provided with an external thread or a screw hole for locking and securing one of the two quick release nuts;
each of the two quick release nuts is provided with a first internal thread screwed onto the external thread of the tube or provided with a first through hole locked onto the screw hole of the tube; and
each of the two quick release nuts is provided with a second internal thread screwed onto the external thread of the drive head and screwed onto the external thread of the connector or provided with a second through hole locked onto the screw hole of the drive head and locked onto the screw hole of the connector.

2. The driving shank assembly as claimed in claim 1, wherein the tube is provided with two outer stepped edges for positioning the two quick release nuts, and each of the two outer stepped edges is located at a connection of the tube and one of the two mounting portions.

3. The driving shank assembly as claimed in claim 1, wherein the driving recess of the drive head has a hexagonal shape or a square shape so that the driving recess of the drive head is available for nuts of different sizes and specifications.

4. The driving shank assembly as claimed in claim 1, wherein the drive head has a periphery provided with a stepped positioning edge for positioning one of the two quick release nuts.

5. The driving shank assembly as claimed in claim 1, wherein the connector has a periphery provided with a stepped positioning edge for positioning one of the two quick release nuts.

6. The driving shank assembly as claimed in claim 1, further comprising:
a holding cylinder mounted on the tube; and
an elastic member S biased between the tube 10 and the holding cylinder;
wherein:
the holding cylinder is not rotated with the tube to facilitate a user holding the holding cylinder;
each of the two quick release nuts has an exterior provided with a stepped positioning edge for positioning the holding cylinder;
the holding cylinder is provided with two positioning edges each positioning the stepped positioning edge of one of the two quick release nuts;
each of the two quick release nuts has a periphery provided with a stepped outer abutting edge abutting the elastic member;
the holding cylinder is provided with a spring groove and a stepped inner abutting edge;
the elastic member is received and hidden in the spring groove;
the elastic member is positioned without sliding; and
the elastic member has a first end pressing the stepped outer abutting edge and a second end pressing the stepped inner abutting edge.

7. A driving shank assembly comprising:
a tube, a drive head, a connector, and two quick release nuts;
wherein:
the tube is a hollow straight tube;
the tube has two mounting portions formed on two ends thereof;
each of the two mounting portions of the tube is provided with a non-circular fitting portion for fitting and securing each of the two quick release nuts;
the drive head is provided with a driving recess;
the drive head is provided with a non-circular fitting portion for fitting and securing one of the two quick release nuts;
the connector is provided with a connecting head for mounting an actuating tool;
the connector is provided with a non-circular fitting portion for fitting and securing one of the two quick release nuts; and
each of the two quick release nuts is provided with a non-circular fitting hole fitted and secured on the fitting portion of the tube, the fitting portion of the drive head, and the fitting portion of the connector.

8. The driving shank assembly as claimed in claim 7, wherein the tube 10 is provided with two outer stepped edges for positioning the two quick release nuts, and each of the two outer stepped edges is located at a connection of the tube and one of the two mounting portions.

9. The driving shank assembly as claimed in claim 7, wherein the driving recess of the drive head has a hexagonal shape or a square shape so that the driving recess of the drive head is available for nuts of different sizes and specifications.

10. The driving shank assembly as claimed in claim 7, wherein the drive head has a periphery provided with a stepped positioning edge for positioning one of the two quick release nuts.

11. The driving shank assembly as claimed in claim 7, wherein the connector has a periphery provided with a stepped positioning edge for positioning one of the two quick release nuts.

12. The driving shank assembly as claimed in claim 7, wherein:
each of the two mounting portions has an exterior provided with a screw hole for locking and securing each of the two quick release nuts;
the drive head has an exterior provided with a screw hole for locking and securing one of the two quick release nuts;
the connector has an exterior provided with a screw hole for locking and securing one of the two quick release nuts;
each of the two quick release nuts is provided with a first through hole locked onto the screw hole of the tube; and
each of the two quick release nuts is provided with a second through hole locked onto the screw hole of the drive head and locked onto the screw hole of the connector.

13. The driving shank assembly as claimed in claim 7, wherein the tube is provided with two holes, the drive head is provided with a hole, the connector is provided with a hole, each of the two quick release nuts is provided with two holes, and pins extend through the two holes of each of the two quick release nuts, the two holes of the tube, the hole of the drive head, and the hole of the connector.

14. The driving shank assembly as claimed in claim 7, wherein the fitting portion of the tube, the fitting portion of the drive head, the fitting portion of the connector, and the fitting hole of each of the two quick release nuts have a polygonal or hexagonal shape.

15. The driving shank assembly as claimed in claim 7, wherein:
each of the two mounting portions of the tube has a periphery provided with multiple positioning slots extending along an axis of the tube;
each of the positioning slots of the tube is provided with a positioning face;
the drive head is provided with multiple positioning projections inserted into and positioned in the positioning slots of one of the two mounting portions of the tube; and
the connector is provided with multiple positioning projections inserted into and positioned in the positioning slots of one of the two mounting portions of the tube.
